(19) United States
(12) Patent Application Publication
(10) Pub. No.: US 2009/0298476 A1
(43) Pub. Date: Dec. 3, 2009

(54) APPARATUS AND METHOD FOR DISPLAYING RELEVANT MESSAGES

(75) Inventors: Woo-Jun Choi, Suwon-si (KR); Young-Seop Han, Dalseo-gu (KR); Dae-Hyun Sim, Seoul (KR); Beom-Soo Cho, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/472,934

(22) Filed: May 27, 2009

(30) Foreign Application Priority Data
May 27, 2008 (KR) 10-2008-0049350

(51) Int. Cl. H04W 4/14; H04W 99/00; H04M 3/42

(52) U.S. Cl. 455/412.2; 455/414.1; 455/466

(57) ABSTRACT

An apparatus and method for displaying a relevant message in a mobile terminal. The mobile terminal determines whether there is a message relevant to a message that it wants to store. When there is a relevant message, the mobile terminal groups the message it desires to store and the relevant message, and stores the grouped messages. When there is a request for displaying a message relevant to a displayed message while displaying the message on a screen, the mobile terminal displays the requested relevant message on the screen, so that a user can check the relevant messages without the need to separately search an incoming message box and/or an outgoing message box.

### PRIORITY

This application claims priority under 35 U.S.C. §119(a) to a Korean Patent Application filed in the Korean Intellectual Property Office on May 27, 2008 and assigned Serial No. 10-2008-0049350, the disclosure of which is incorporated herein by reference.

### BACKGROUND OF THE INVENTION

1. Field of the Invention

The present invention relates to an apparatus and method for displaying relevant messages. More particularly, the present invention relates to an apparatus and method for displaying messages relevant to a message displayed on a screen of a mobile terminal.

2. Description of the Related Art

A communication terminal, such as a mobile terminal, can exchange Short Message Service (SMS) messages with its counterpart communication terminal using an SMS messaging service. While the messages are exchanged, incoming messages received at a mobile terminal of a user are stored in an incoming message box and outgoing messages sent to a mobile terminal of the other party are stored in an outgoing message box.

For example, when a user wants to recheck incoming messages previously received from the other party while reading the content of an incoming message in an incoming message box, the user can only search for the previously received messages after closing the incoming message, and only then can the user read the content of the searched messages. Also, when the user wishes to recheck outgoing messages that were sent to other parties, while reading the content of an incoming message, the user must move from the incoming message box to the outgoing message box, search for the pertinent outgoing messages, and then read the content of the searched messages.

In this manner, when a user wants to reread the contents of outgoing messages previously sent, while reading the content of an incoming message in an incoming message box of the mobile terminal, the user must move from the incoming message box to the outgoing message box, and search for outgoing messages stored in the outgoing message box. Also, even when the user wants to recheck previously stored incoming messages while reading the content of an incoming message in the incoming message box, the user must search for the incoming messages stored in the incoming message box.

### SUMMARY OF THE INVENTION

Accordingly, an aspect of the present invention is to provide an apparatus and method for displaying messages relevant to a message displayed on a screen of a mobile terminal.

According to one aspect of the present invention, there is provided a method for displaying a relevant message in a mobile terminal. The method includes, when storing a message, determining whether there is a message relevant to the stored message; when there is a message relevant to the stored message, grouping the stored message and the relevant message, and storing the grouped messages; and when there is a request for displaying a message relevant to a displayed message while displaying a message on a screen, displaying the requested relevant message on the screen.

According to another aspect of the present invention, there is provided an apparatus for displaying a relevant message. The apparatus includes a memory for storing a message; a display for displaying the stored message; and a controller including, when storing a message, determining whether there is a message relevant to the stored message; when there is a message relevant to the stored message, grouping the stored message and the relevant message, and storing the grouped messages in the memory; and when there is a request for displaying a message relevant to a displayed message while displaying the message, displaying the requested relevant message on the display.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram illustrating a structure of a mobile terminal according to an embodiment of the present invention;

FIG. 2 is a diagram illustrating an exemplary format of an SMS message according to an embodiment of the present invention;

FIG. 3 is a diagram illustrating a message table in which relevant incoming and outgoing messages are sorted and stored according to an embodiment of the present invention;

FIGS. 4A to 4C are diagrams illustrating an exemplary process of displaying messages relevant to a message displayed on a screen according to an embodiment of the present invention; and

FIG. 5 is a control flowchart illustrating a procedure for displaying messages relevant to a message displayed on a screen according to an embodiment of the present invention.

Throughout the drawings, the same drawing reference numerals will be understood to refer to the same elements, features and structures.

### DETAILED DESCRIPTION OF PREFERRED EMBODIMENTS

Embodiments of the present invention will now be described in detail with reference to the annexed drawings. In the following description, a detailed description of known functions and configurations incorporated herein has been omitted for clarity and conciseness.

A detailed description will now be made of a structure and operation of a mobile terminal for displaying relevant messages according to an embodiment of the present invention. In an embodiment of the present invention, an SMS message format will be used as a message format by way of example.

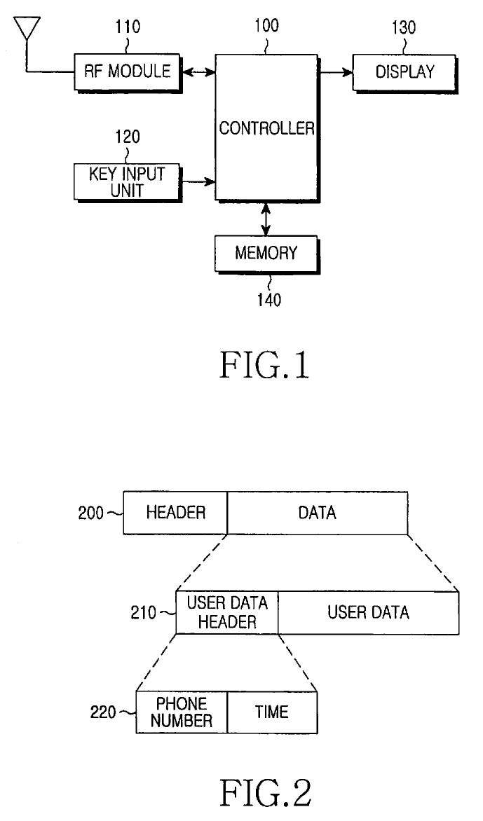

FIG. 1 illustrates a structure of a mobile terminal according to an embodiment of the present invention.

Referring to FIG. 1, a mobile terminal includes a controller 100, a Radio Frequency (RF) module 110, a key input unit 120, a display 130, and a memory 140.

The controller 100 controls the overall operation of the mobile terminal. When sending or receiving messages, the controller 100 sorts relevant incoming and outgoing messages based on their received/sent times, and stores the messages in incoming and outgoing message boxes in the memory 140. When a key input for sending a message is entered through the key input unit 120, the controller 100 displays on the display 130 a compose message menu screen provided for sending a message. When a key input for sending a message is received after the composing of a message is completed, the controller 100 sends the written message to a mobile terminal corresponding to a phone number entered during the writing of the message, through the RF module 110. Thereafter, the controller 100 stores the sent message in the outgoing message box in the memory 140, during which the controller 100 groups the corresponding message and its relevant messages and stores the grouped messages in the memory 140. In other words, the controller 100 identifies messages relevant to the corresponding message, sorts the corresponding message and the identified messages together in time order, and stores the messages in the memory 140. As a result, the user can check messages relevant to a message being displayed on the screen in time order.

A description will now be made of an operation in which the controller 100 determines whether there is any message relevant to a message the controller 100 intends to store.

The controller 100 first determines if a message the controller 100 intends to store is a reply message in order to distinguish relevant messages from irrelevant messages. Since it is hard to check if the corresponding message is a reply message based solely on the message, the controller 100 can insert a tag for indicating a reply message into a particular field among message fields before sending the message. A detailed description thereof will now be made with reference to FIG. 2. The controller 100 can insert a reply indication tag for indicating a reply message into a reserved region corresponding to an unused region of a header field 200 among the SMS message fields. For instance, the controller 100 can use one byte of 0 or 1 as the reply indication tag. Alternatively, the controller 100 can insert the reply indication tag in a partial region of a user data field 210 among the message fields. For example, the controller 100 can use 1 byte out of the bytes in which a normal message can be inserted, as a space in which the controller 100 will insert the reply indication tag. Also, the controller 100 can insert the reply indication tag in an unused region of a phone number field 220 among the message fields. As a result, upon receiving a message with the reply indication tag, a mobile terminal can determine that the incoming message is a reply message by checking the reply indication tag included in the corresponding region.

After checking whether the message the controller 100 desires to store is a reply message, the controller 100 identifies messages having receiving and sending information which is identical to receiving and sending information of the message the controller 100 whishes to store. To identify relevant messages, the controller 100 identifies messages whose receiving and sending information is similar or identical to that of the desired message. The controller 100 first determines whether the message the controller 100 desires to store is a reply message in order to distinguish relevant messages from irrelevant messages. The receiving and sending information may include parameters such as, for example, reply information indicating whether an incoming or outgoing message is a reply message, names of a recipient and a sender, a message received time, and a message sent time. For example, regarding the messages indicating that their incoming messages are reply messages, if the names of their senders are the same names corresponding to phone numbers of recipients and senders, stored in the mobile terminal, and the message received times and/or message sent times fall within a predetermined time, they are determined as relevant messages. In contrast, for messages indicating that the incoming messages are not reply messages, and the names of their senders are not identical to names corresponding to phone numbers of recipients and senders, stored in the mobile terminal, these messages would be determined as irrelevant messages.

When an incoming message is received via the RF module 110, the controller 100 stores the received message in an incoming message box in the memory 140. In this case, as described above, the controller 100 identifies relevant messages, sorts the relevant messages in time order, and then stores the messages in the memory 140.

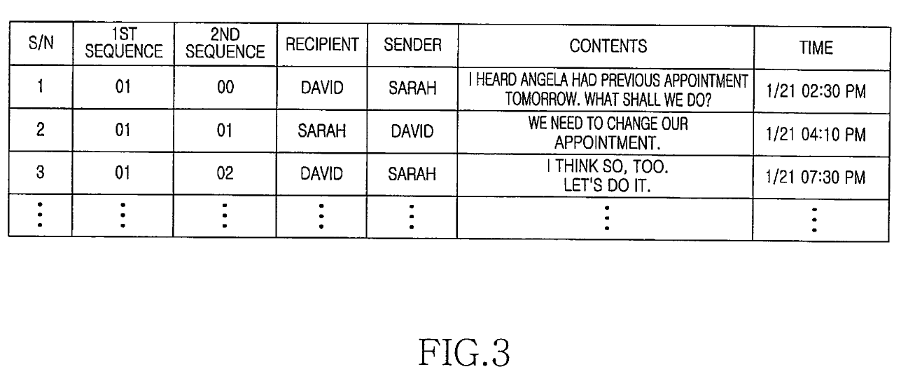

The relevant incoming and outgoing messages are sorted as shown in FIG. 3 and then stored in the memory 140.

FIG. 3 is a diagram illustrating a message table in which relevant incoming and outgoing messages are sorted in time order and then stored according to an embodiment of the present invention.

In order to sort and store the relevant incoming and outgoing messages together, the controller 100 can store incoming and outgoing messages taking into account whether the incoming and outgoing messages are reply messages, the names of the senders, and the received/sent times. As shown in FIG. 3, the present invention adds a first sequence field for indicating relevant messages and a second sequence field used for sorting relevant messages in time order.

For example, when receiving through the RF module I 10 a message indicating that the incoming or outgoing message is not a reply message, or storing a new outgoing message, the controller 100 determines whether there is any message relevant to the corresponding incoming or outgoing message. When there is no relevant message, the controller 100 assigns a new number to a first sequence field in the incoming or outgoing message, assigns a default value ‘00’ to a second sequence field, and stores the incoming or outgoing message. The controller 100 determines that there is no relevant message when there is no message which indicates that the incoming or outgoing message is not a reply message and does not correspond to the same name as a sender's name of an incoming message or a recipient's name of an outgoing message, and which is received or sent within a preset time.

If there is a relevant message, the controller 100 assigns the same number as the first sequence field's number of the relevant message to a first sequence field of the incoming or outgoing message, assigns a new number to a second sequence field, and stores the incoming or outgoing message. In this case, the controller 100 determines that there is a relevant message when the incoming or outgoing message is a reply message. Further, the controller 100 determines that there is a relevant message when there is a message which indicates that the incoming or outgoing message is a reply message and which corresponds to the same name as a sender's name of an incoming message or a recipient's name of an outgoing message, which is received or sent within a preset time. Here, the second sequence field's number of the incoming or outgoing message can become the next number of the second sequence field's number of the relevant message.

Upon receiving a reply message through the RF module 110, the controller 100 checks parameters, such as a sender of the received reply message and the received time of the message, and if a relevant message is identified, the controller 100 assigns the same number as the number assigned to a first sequence field of the identified relevant message to a first sequence field of the incoming or outgoing message, assigns a new number to a second sequence field, and stores the incoming or outgoing message.

An example of an embodiment of the present invention will be described with reference to FIG. 3. When a message (message #1) “I heard Angela had a previous appointment tomorrow. What shall we do?” is received by David from Sarah at 02:30 pm on January 21, the controller 100 determines if the received message is a reply message. When the received message is not a reply message, the controller 100 assigns “01” to a first sequence field, assigns a default value “00” to a second sequence field, and stores the received incoming message. Thereafter, if David sends a reply message (message #2) “We need to change our appointment” to Sarah at 04:10 pm on January 21, the controller 100 attempts to identify a message relevant to the corresponding outgoing message. The controller 100 can identify as a relevant message a message for which a name of a sender is equal to a name corresponding to a sender's phone number and a difference between a message received time and a message sent time falls within a preset time. If it is determined that the outgoing message is relevant to the message #1, the controller 100 assigns the same number “01” as the first sequence field's number of the message #1 to a first sequence field of the outgoing message, assigns a new number “01” to a second sequence field, sorts the messages in time order, and stores the message. Thereafter, when a reply message “I think so, too. Let's do it” is received by David from Sarah at 07:30 pm on January 21, the controller 100 determines if the received message is a reply message, and identifies a message relevant to the incoming message as described above. If it is determined that the incoming message is a reply message and is also a message relevant to the messages #1 and #2, the controller 100 assigns “01” to a first sequence field in the corresponding incoming message, assigns “02” to a second sequence field, sorts the messages in time order, and stores the message. In this manner, the controller 100 assigns the same first sequence number to all of the incoming message and messages relevant thereto, thereby making it possible to group together the incoming message and its relevant messages.

When a request for displaying a message is entered through the key input unit 120 after storing the outgoing and incoming messages, the controller 100 searches the memory 140 for the requested message and displays the contents of the searched message on the display 130. Thereafter, when a request for displaying a particular relevant message among the messages relevant to the displayed message is entered through the key input unit 120, the controller 100 displays the contents of the requested message by means of the display 130.

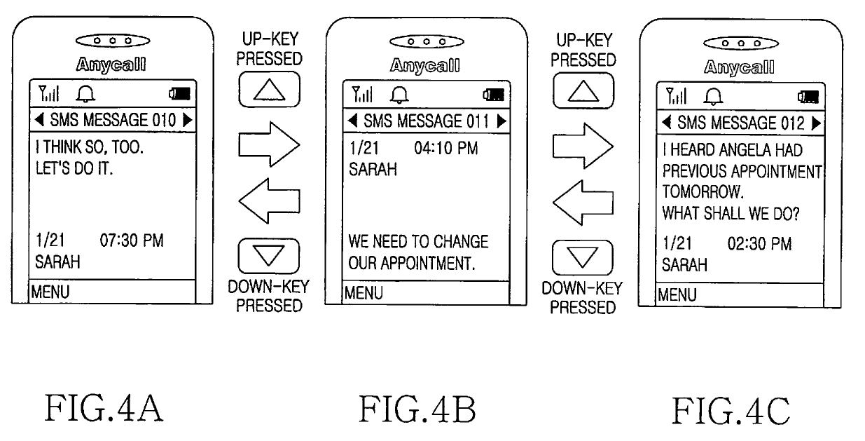

A detailed description thereof will be made below with reference to FIGS. 4A to 4C.

FIGS. 4A to 4C are diagrams illustrating an exemplary process of displaying messages relevant to a message displayed on a screen in response to a key input.

For example, when a key input for displaying a message #2 shown in FIG. 3 is entered, the controller 100 displays the message #2 on the display 130 as shown in FIG. 4B. Thereafter, when a key input for displaying a message whose sent or received time precedes the received time of the message #2 is entered through the key input unit 120, the controller 100 displays on the display 130 a message #1 that has the same first sequence number as that of the message #2 and has a second sequence number preceding the second sequence number of the message #2 as shown in FIG. 4A. In addition, when a key input for displaying a message whose sent or received time follows the received time of the message #2 is entered through the key input unit 120, the controller 100 displays on the display 130 a message #3 that has the same first sequence number as that of the message #2 and has a second sequence number following the second sequence number of the message #2 as shown in FIG. 4C. In the present invention, Up/Down keys or Left/Right keys provided on the key input unit 120 may be used to display relevant messages. In this way, the controller 100 can display the messages a user wants to recheck from among the messages relevant to the message displayed on the screen, on the screen in order of their received/sent time. As a result, the user can directly recheck, on the screen, the messages relevant to the message displayed on the screen without the need to search the incoming and outgoing message boxes for the relevant messages.

The RF module 110 sends generated messages to the counterpart mobile terminal, and receives messages from the counterpart mobile terminal. The key input unit 120 includes a key for displaying a message on the screen and a key for displaying messages relevant to the displayed message on the screen, and delivers data of a key value corresponding to a key pressed by the user, to the controller 100.The display 130 displays on the screen the contents of a message selected by means of the key input unit 120.The memory 140 includes an incoming message box and an outgoing message box, stores received messages in the incoming message box and sent messages in the outgoing message box.

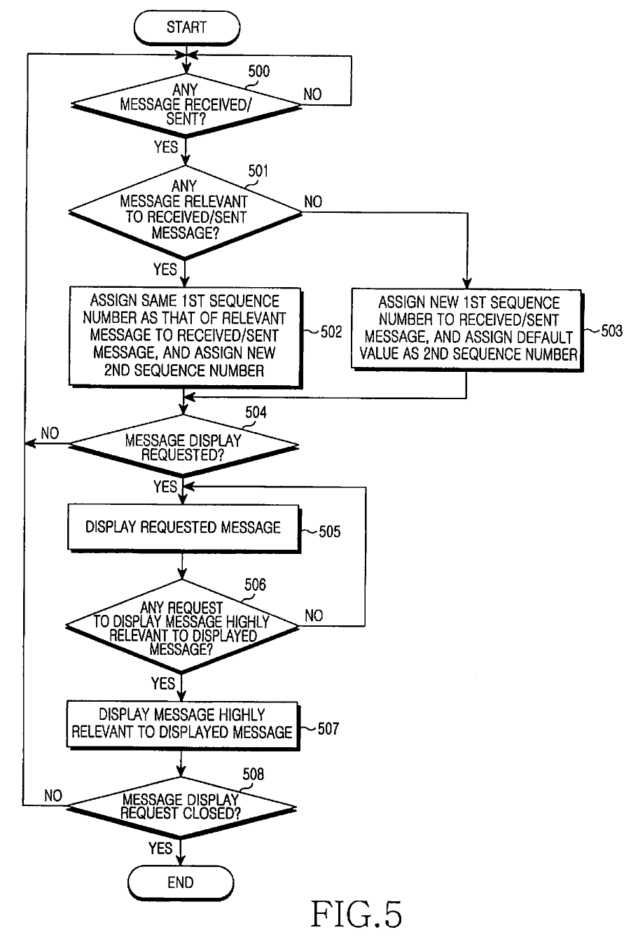

With reference to FIG. 5, a description will now be made of a procedure for displaying messages relevant to a message displayed on a screen in a mobile terminal constructed as shown in FIG. 1 according to an embodiment of the present invention.

A controller 100 determines in step 500 whether an operation of receiving or sending a message is being carried out. If the operation is being performed, the controller 100 proceeds to step 501, and otherwise, continues to determine whether the operation of receiving or sending a message is being performed.

In step 501, the controller 100 determines whether there is any message relevant to an incoming or outgoing (i.e. received or sent) message when storing the incoming or outgoing message. When there is a relevant message, the controller 100 proceeds to step 502, and otherwise proceeds to step 503. As described above, whether a certain message is a relevant message can be determined by determining whether the message is a reply message, whether a name of a sender is to the same as a name corresponding to a sender's phone number, and whether the message received or sent time falls within a predetermined time.

In step 502, the controller 100 assigns the same first sequence number as that of the relevant message identified through step 501 to a first sequence field of the incoming or outgoing message, assigns a new second sequence number to a second sequence field, and stores the incoming or outgoing message in the memory 140. Thus, the controller 100 can sort relevant messages and store them in the memory 140.

In step 503, the controller 100 assigns a new first sequence number to the first sequence field of the incoming or outgoing message, assigns a default value to the second sequence field, and stores the incoming or outgoing message in the memory 140.

After steps 502 and 503, the controller 100 determines in step 504 whether a request for displaying a message on the screen is entered through a key input unit 120. When the request is received, the controller 100 proceeds to step 505. Otherwise, the controller 100 returns to step 500 where it determines whether an incoming or outgoing message is received or sent, and then repeats steps 501 to 503.

In step 505, the controller 100 searches the memory 140 for the requested message, and displays the contents of the searched message on the display 130. The message can be displayed on the display 130 as shown in FIG. 4B.

In step 506, the controller 100 determines whether a request for displaying a message relevant to the message displayed on the screen is received. When the request is received, the controller 100 proceeds to step 507, and otherwise returns to step 505 where it continues to display the requested message on the screen.

In step 507, the controller 100 searches for a message relevant to the message displayed on the screen, and displays the searched message on the screen. The relevant message has the same first sequence number as that of the message currently displayed on the screen, and has a second sequence number preceding or following the second sequence number of the message presently displayed on the screen. For example, when a Down key is entered while the message shown in FIG. 4B is displayed on the screen, the display 130 displays the contents of the message as shown in FIG. 4A, and when an Up key is entered, the display 130 displays the contents of the message as shown in FIG. 4C.

After step 507, the controller 100 determines in step 508 whether the request for displaying a message is closed. When the request is closed, the controller 100 ends the message display operation, and otherwise repeats steps 500 to 507.

As described above, when storing outgoing and incoming messages, the present invention groups relevant messages, sorts the grouped relevant messages in time order, and stores them, so that the user can directly check the messages relevant to an arbitrary message on the screen without the need to search the incoming message box and the outgoing message box.

An example of the present invention has been described that identifies relevant messages, sorts the relevant messages in time order, and then stores the sorted messages, in the process of storing outgoing and incoming messages. However, when a message display request is received from the user, the present invention can also detect relevant messages among the messages stored in the mobile terminal, sort them in time order, and then display a message selected by a key input.

As is apparent from the foregoing description, when there is a request for displaying a message relevant to a message displayed on a screen of the mobile terminal, the present invention can directly display the requested message in response to a key input, so that the user can directly check the relevant message without the need to separately search the incoming message box and/or the outgoing message box. As a result, the user can conveniently check the contents of the incoming/outgoing messages without the need to move from menu to menu to search for messages.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for displaying a relevant message in a mobile terminal, the method comprising the steps of:
when storing a sending or receiving message, determining whether there is a stored message relevant to the sending or receiving message;
if there is a stored message relevant to the sending or receiving message, grouping the stored message and the relevant stored message to identify that the message and the relevant stored message are related to each other, and storing the grouped messages; and
when there is a request for displaying a message relevant to a displayed message while displaying a message on a screen, displaying the grouped relevant messages on the screen based on the request.

2. The method of claim 1, further comprising:
when it is determined that there is no stored message relevant to the sending or receiving message, creating a new group containing the sending or receiving message, and storing the new group.

3. The method of claim 1, wherein the determination of whether there is a relevant message comprises:
determining if there is at least one stored message which is similar in receiving or sending information to the sending or receiving message; and
if there is at least one stored message which is similar in the receiving or sending information to the sending or receiving message, determining that the stored message is relevant to the sending or receiving message.

4. The method of claim 3, wherein the receiving information comprises at least one of a recipient's name and a recipient's phone number, and the sending information comprises at least one of a sender's name and a sender's phone number.

5. The method of claim 3, wherein the grouping of the stored message and the relevant message and the storing of the grouped messages comprises:
when the sending or receiving message is determined to be relevant to the stored message, sorting the stored message and the sending or receiving message in time order using received or sent times contained in the receiving or sending information.

6. An apparatus for displaying a relevant message, the apparatus comprising:
a memory for storing a sending or receiving message;
a display for displaying the stored message; and
a controller for:
when storing a sending or receiving message, determining whether there is a stored message relevant to the sending or receiving message;
when there is a stored message relevant to the sending or receiving message, grouping the sending or receiving message and the stored message, and storing the grouped messages in the memory; and
when there is a request for displaying a message relevant to a displayed message while displaying the message, displaying the grouped message according to the request.

7. The apparatus of claim 6, wherein when it is determined that there is no stored message relevant to the sending or receiving message, the controller creates a new group containing the sending or receiving message and stores the new group in the memory.

8. The apparatus of claim 6, wherein in determining whether there is a stored message relevant to the sending or receiving message, the controller determines if there is at least one stored message which is similar in sending or receiving information to the message, and if there is at least one stored message which is similar in the sending or receiving information to the sending or receiving message, the controller determines that the stored message is relevant to the sending or receiving message.

9. The apparatus of claim 8, wherein the receiving information comprises at least one of a recipient's name and a recipient's phone number, and the sending information comprises at least one of a sender's name and a sender's phone number.

10. The apparatus of claim 8, wherein in grouping the stored message and the relevant message and storing the grouped messages, the controller includes:
when the sending or receiving message is determined to be relevant to the stored message, sorting the stored message and the sending or receiving message in time order using received or sent times contained in the receiving or sending information, and storing the sorted messages in the memory.
